(19) United States
(12) Patent Application Publication
(10) Pub. No.: US 2012/0126446 A1
(43) Pub. Date: May 24, 2012

(54) METHOD AND PLANT FOR PRODUCING A CONCRETE BODY

(76) Inventors: Maik Rower, Obernkirchen (DE); Benno Bohm, Borken (DE); Burkhard Marczok, Rinteln (DE)

(21) Appl. No.: 13/319,212

(22) PCT Filed: Apr. 23, 2010
(86) PCT No.: PCT/EP10/55488

§ 371 Date: Jan. 23, 2012

(30) Foreign Application Priority Data
May 13, 2009 (DE) 10 2009 021 123.3

(51) Int. Cl. B29C 47/08; B29C 47/00; B29C 47/12

(52) U.S. Cl. 264/177.17; 425/377; 264/151; 425/308

(57) ABSTRACT

The invention relates to a method for producing a concrete body having a planar upper side, wherein a high surface quality is obtained. In the method, a concrete body is extruded from unset concrete and is provided with a groove profile at the upper side thereof by means of a profiling unit. By means of the profiling unit and depending on the comb-shaped profile thereof, the sand particles are separated according to size, wherein large sand particles are displaced from the surface area of the concrete body toward the inside, this being toward the interior of the concrete body. Only fine sand particles can pass the profile, whereby raised areas of the groove profile are formed, which are made of extremely fine-grained unset concrete. Subsequently, the upper side of the concrete body is leveled by means of a leveling unit, wherein the raised areas of the groove profile are crushed and the fine-grained unset concrete of the raised areas of the groove profile is distributed to form a cover layer.

The invention relates to a method for the production of a concrete body according to the preamble of patent claim 1 as well as to a plant for the production of the concrete body according to patent claim 5.

A method is known (DE 35 22 846 A1) for the production of concrete roof tiles using the extrusion method, in which onto a lower mold delivered in a continuous strand to a coating installation a layer of green concrete is applied and the concrete is subsequently compacted and profiled by means of a shaping roller and smoother. The green concrete layer thus compacted is subsequently cut into individual roof tiles in a cutting station. Since the green concrete utilized for the production of the roof tiles has a relatively large sand grain size, the roof tiles have a rough porous surface. The surface of the roof tiles is therefore provided with a color coating to seal and smooth it.

For further improvement of the surface quality in roof tiles, production methods have been developed in which the roof tile is provided with a fine-grained mineral surface layer. Such a method is described for example in DE 39 32 573 C2. Herein, first, from a coarse-grained green concrete mixture a roof tile is extruded whose upper side is subsequently provided by a profiled smoother with a multiplicity of flutes extending in the longitudinal direction of the roof tile. Onto the surface of the roof tile subsequently a coating of a very fine-grained green concrete is extruded which lends the roof tile a surface layer with a very smooth surface. The flutes are retained since they serve to effect a mechanical grip between the roof tile and the coating. However, the known method entails complex production engineering since the roof tile and the surface layer is produced of two different green concrete mixtures with sand grains of varying fine grain size.

U.S. Pat. No. 4,666,648 A also discloses providing the upper side of a roof tile with a profile. However, the profiling here takes place for different purposes. In U.S. Pat. No. 4,666,648 A a method is disclosed for the production of roof tiles, in which, by means of an irregularly profiled profiling unit, a profile is applied on the upper side of the roof tile. This profile consists of several grooves one next to the other and oriented in the longitudinal direction, which imitate a wood grain pattern. Onto this roof tile, subsequently brown coloring agent is applied such that the roof tiles thus produced have the appearance of wood shingles.

A method is furthermore described in which onto the upper side of a roof tile grooves are applied as a decoration (JP 2000-328721 A). Smoothing of the roof tile after the grooves have been applied does not take place.

The present invention therefore addresses the problem of providing a concrete body produced of extruded green concrete, comprising only one concrete mixture which has a very smooth surface as well as high surface quality and which is simple of production.

This problem is resolved according to the features of patent claims 1 and 5.

The method according to the invention dispenses with the production and the separate application of a fine-grained concrete mixture as a surface layer. For the production of the roof tile only one green concrete mixture is utilized. The improvement of the surface quality is attained thereby that a method for the production of a concrete body with a flat upper side is provided. From green concrete a concrete body is herein extruded which is provided by a profiling unit with a groove profile on its upper side. By means of the profiling unit and as a function of its profile, the separation of the sand particles according to particle size takes place, wherein large sand particles are displaced from the surface region of the concrete body inwardly, which means into the interior of the concrete body. Only fine sand particles can pass the profile, whereby on the surface of the concrete body a groove profile with elevations is formed. These elevations of the groove profile are comprised of fine-grained concrete. The upper side of the concrete body is subsequently smoothed by means of a levelling unit. The elevations are herein squashed whereby the fine-grained concrete of the elevations is distributed and forms a surface layer.

The invention also relates to a plant for the production of a concrete body with such a flat upper side. The plant comprises a working station with an extrusion arrangement for the extrusion of a concrete body of green concrete and a profiling unit downstream in the extrusion direction for generating a groove profile on the upper side of the concrete body, the profiling unit having a profile with webs extending parallel to one another in the extrusion direction. Via an interval distance b of the webs with respect to one another, a limit value for size-dependent separation of the sand particles is predetermined. The plant also comprises a levelling unit for smoothing the profiled upper side of the concrete body.

By smoothing out the upper side of the concrete body, the fine-grained concrete becomes very uniformly distributed and a smooth surface layer is formed in which the air inclusions or pore formations are avoided due to the high packing density. In comparison to the concrete bodies known from DE 35 22 846 A1, the concrete bodies produced according to the invention therefore have a markedly decreased surface roughness. The quantity of the coloring agent application can be considerably reduced due to the lesser surface roughness.

For as smooth a surface of the concrete body as possible, DE 39 32 573 C2 discloses utilizing a concrete mixture with a very fine-grained sand. The use of such sands has the disadvantage that the concrete mixture tends to the formation of bubbles and therewith to increased porosity. With the method according to the invention, in contrast, concrete mixtures with very fine sands can also be processed, for during the separation of the sand particles through the profiled profiling unit these sand particles are moved whereby venting of the concrete mixture takes place. After the smoothing of the upper side of the concrete body, a concrete body is obtained which has a very smooth, that is a flat, surface layer.

An embodiment example of the invention is depicted in the drawing and will be described in further detail in the following. In the drawing show:

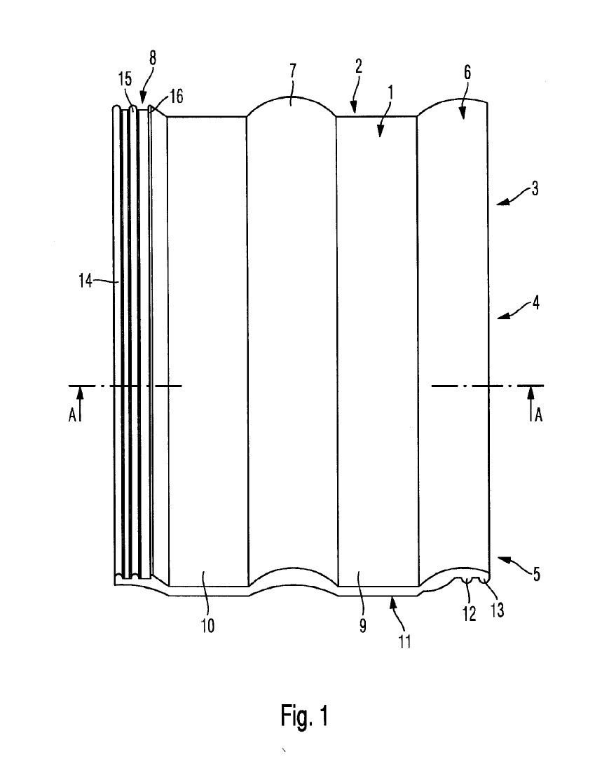

FIG. 1 a top view onto a finished concrete body;

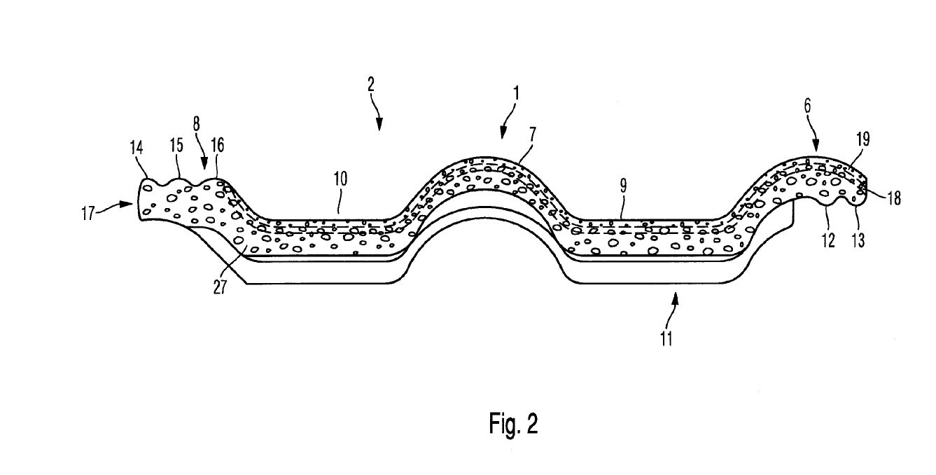

FIG. 2 a section A-A through the concrete body depicted in FIG. 1;

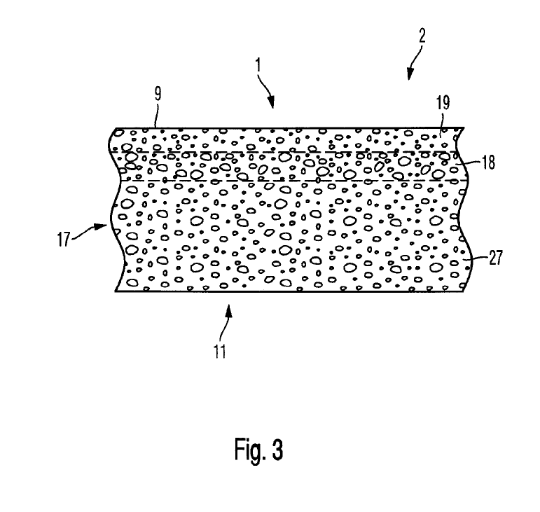

FIG. 3 an enlarged segment of the segment [sic: section] of the concrete body depicted in FIG. 2;

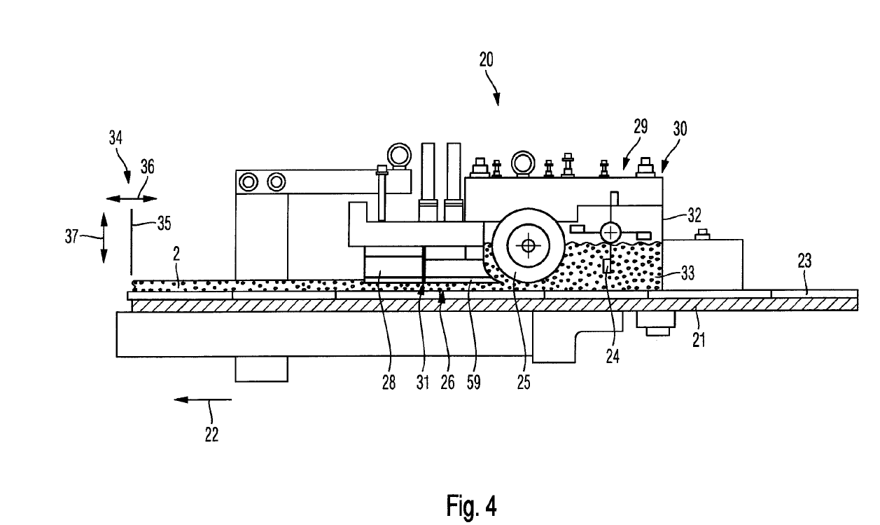

FIG. 4 a side view of a portion of a plant for the production of concrete bodies;

FIG. 5 a perspective view of an underside of a profiling unit;

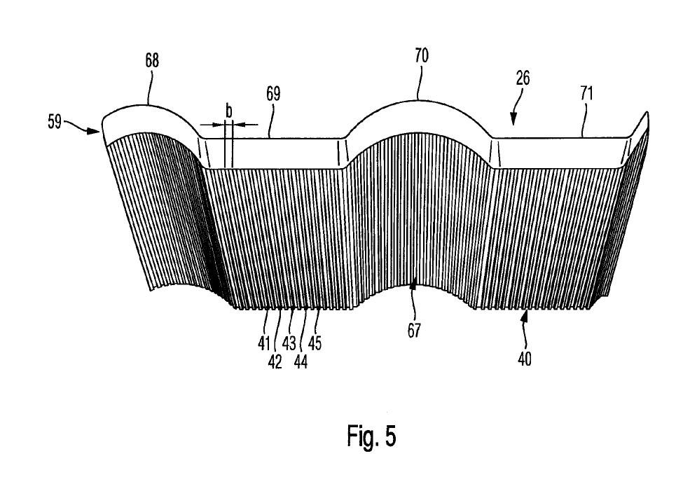

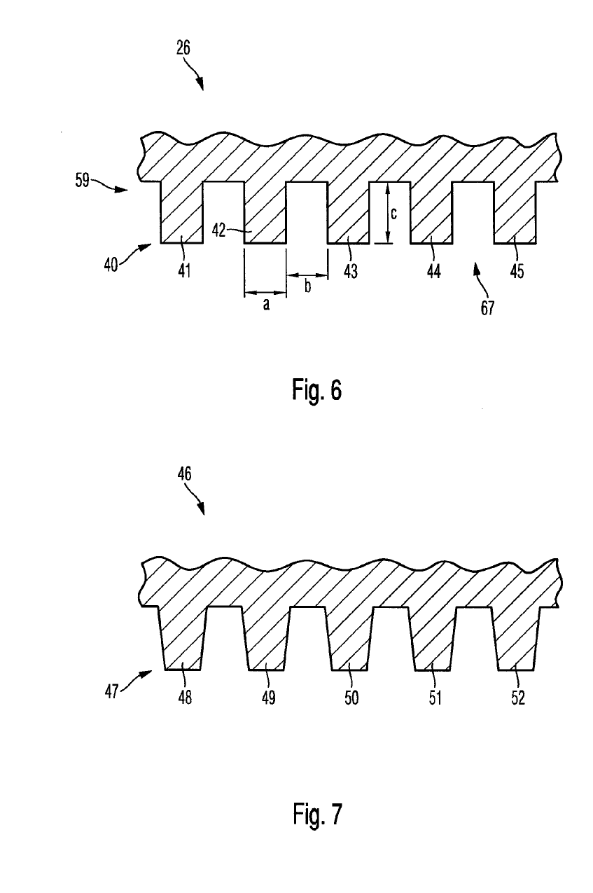

FIG. 6 a segment of the profiling unit depicted in FIG. 5;

FIG. 7 a segment of a variant of the profiling unit depicted in FIG. 5;

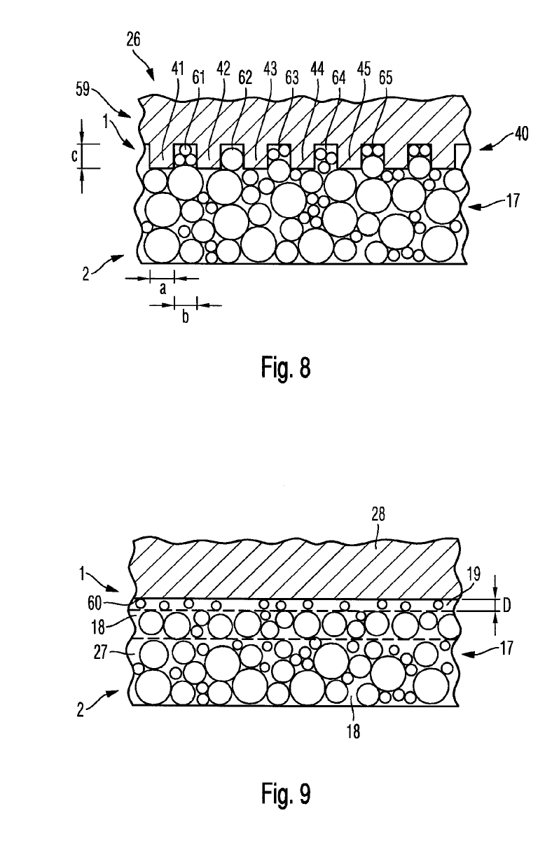

FIG. 8 the application of a groove profile onto a concrete body;

FIG. 9 the levelling of the groove profile disposed on the concrete body according to FIG. 8;

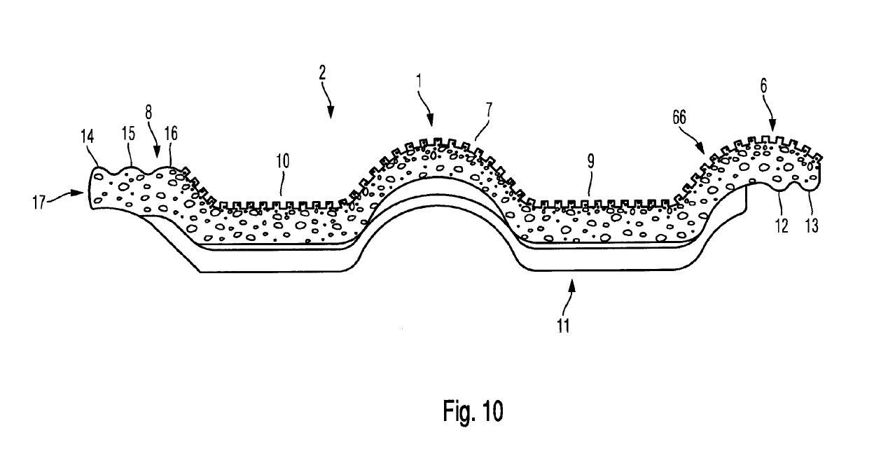

FIG. 10 the concrete body depicted in FIG. 2 with groove profile before the levelling.

FIG. 1 shows a top view onto the upper side 1 of a finished concrete body 2 with head-end section 3, central section 4 as well as a foot-end section 5. This concrete body 2 has the shape of a roof tile, for example the shape of a Frankfurt pan. The concrete body 2 comprises a cover fold 6, a center brim 7 and a water fold 8. Between the cover fold 6 and the center brim 7 as well as between the center brim 7 and the water fold 8 a water course 9, 10 each is disposed. As described for example in DE 10 2005 011 201 A1, in the water courses 9, 10 a water barrier can be disposed. Such a water barrier, however, is not depicted in FIG. 1.

On the underside 11 of the concrete body 2 two cover fold ribs 12, 13 are disposed. These cover fold ribs 12, 13 can engage into a water fold of a second concrete body when a roof is laid with the concrete body 2. However, this is not shown in FIG. 1 for the sake of simplicity. The water fold 8 of the concrete body 2 has several water fold ribs 14, 15, 16. Into these water fold ribs 14, 15, 16 of the concrete body 2 cover fold ribs of a further concrete body can be disposed. Through the cover fold 6 and the water fold 8 it becomes possible to dispose the concrete bodies with precise fit onto one another when laying a roof.

FIG. 2 shows a section A-A through the concrete body 2 depicted in FIG. 1. Evident are again the cover fold 6, the center brim 7, the water fold 8 as well as the two water courses 9 and 10.

The concrete body 2 is comprised of a layer 17 of concrete, which is divided into three regions 18, 19, 27. The region 19 is disposed above the region 18 and nearly completely overlaps the region 18. The upper region 19 consequently forms a surface layer of concrete body 2. Only the water fold 8 is not overlapped by surface layer 19, that is region 19. While regions 18, 19, 27 are comprised of the same green concrete mixture, however regions 18, 19, 27 differ in the mean grain size of the sand particles. In region 19 are thus only arranged sand particles whose grain size is below a certain limit value, while in regions 18 and 27 sand particles with a grain size above this limit value are present. In region 18 sand particles are arranged whose mean grain size is greater than the mean grain size of the sand particles of region 19 and 27.

Region 27 has sand particles with a mean grain size which corresponds to that of the green concrete mixture used for the production of the concrete bodies.

In region 18, consequently, the mean grain size of the sand particles is greatest while the mean grain size of the sand particles in region 19 is smallest. The sand in region 19 is therefore especially fine-grained.

Although not shown in FIG. 2, it is also conceivable for region 19 to be disposed on water fold 8 also. This is however not absolutely necessary since, as a rule, the water fold 8 in a roof structure is overlapped by a cover fold of a further concrete body.

On the upper side 1 as well as on the underside 11 of concrete body 2 additional layers can also be disposed. It is, for example, feasible to dispose on the upper side 1 of concrete body 2, that is on region 19 or the surface layer, a colored layer. However, this is not shown in FIG. 2.

FIG. 3 depicts an enlarged segment of water course 9 of the concrete body 2 shown in FIG. 2. Readily evident is that the concrete layer 17 is divided into three regions 18, 19, 27, namely into the upper region 19 forming the surface layer, the middle region 18 and the lower region 27. In these regions 18, 19 and 27 sand particles are disposed whose mean grain size differs. In regions 18 and 27 sand particles with a grain size are present which do not occur in region 19. Layer 17 with such a grain size distribution cannot be produced by simple smoothing, but rather, in the production of the concrete body 2 in region 19 forming the surface layer, a separation of the sand particles must have taken place as a function of the size of the sand particles. In the present invention this separation of the sand particles according to their size takes place through a profiling unit.

FIG. 4 depicts a side view of a segment of a plant 20 for the production of concrete bodies using the extrusion method. This segment of plant 20 comprises a working station 29 with an extrusion arrangement 30, a surface working unit 31 and a belt conveyor 21 for conveying a continuous strand of lower molds 23 on which subsequently rest the band-shaped concrete body 2 of green concrete extruded onto the lower molds. The surface working unit 31 is downstream of the extrusion arrangement 30 and comprises a profiled profiling unit 26 and a levelling unit 28. The levelling unit 28 comprises a non-profiled, that is a smooth, underside. The lower molds 23 to be filled with green concrete are first conducted by the belt conveyor 21 to the extrusion arrangement 30.

This extrusion arrangement 30 includes a material box 32 supplied with green concrete 33. This green concrete 33 has sand particles of various grain sizes. After the lower molds 23 have entered the material box 32, green concrete 33 is applied onto these lower molds 23. In the material box 32 are disposed a spiked shaft 24 and a profiled roller 25. In a first step the spiked shaft 24 presses the green concrete 33 into the lower molds 23. In a second step the green concrete is subsequently compacted through the profiled roller 25 into a band-shaped concrete body 2, the body simultaneously receiving the desired profile. With the plant 20 shown here the concrete body 2 receives a cross sectional profile.

The band-shaped concrete body 2 is subsequently conducted to the surface working unit 31, the concrete body 2 first passing the profiling unit 26. This profiling unit 26 has in a lower region 59 a profile, preferably a comb-like profile. However, this profile is not visible in FIG. 4. By means of this profile of the profiling unit 26 onto the upper side 1 of the concrete body 2 a groove profile is applied by moving the concrete body 2 underneath the profiling unit 26 in the transport direction 22. By means of the profile of the profiling unit 26 herein a separation of the sand particles according to their particle size takes place. Through this separation of the sand particles large sand particles are displaced inwardly out of the surface region of concrete body 2 while fine sand particles can pass the profile of the profiling unit 26 and thus remain in the surface region of concrete body 2, that is in elevations of the groove profile. The fine sand particles herein have a mean particle size which is less than the mean particle size of the large sand particles.

When passing the profiling unit 26, consequently, on the surface 1 of concrete body 2, elevations of the groove profile are formed which are comprised of a very fine concrete. Simultaneously, air inclusions in the concrete can escape. After the groove profile has been applied on the concrete body 2 by means of the profiling unit 26, the concrete body 2 is moved in the direction toward a levelling unit 28. This levelling unit 28 serves for obliterating the groove profile applied on the concrete body 2. The concrete body 2 is herein moved underneath the levelling unit 28 in the transport direction 22, wherein the levelling unit 28 levels the upper side 1 of the concrete body 2. This levelling takes place by squashing the elevations of the groove profile whereby the very fine-grained concrete of the elevations of the groove profile is uniformly distributed on the surface region of concrete body 2 and the upper region 19 is developed which forms the surface layer of concrete body 2 depicted in FIGS. 2 and 3. The upper region 19 can also be referred to as the surface layer 19. After the groove profile of the surface 1 of concrete body 2 has been levelled, the band-shaped concrete body 2 is conducted in the transport direction 22 to a cutting station 34 depicted only schematically in FIG. 4. In this cutting station 34 the band-shaped concrete body 2 is cut into individual roof tiles by means of a cutting tool 35 movable reversingly to transport (cf. double arrow 36) and perpendicularly (cf. double arrow 37) with respect to the concrete body 2. Onto the upper side of the roof tiles subsequently a coloring agent layer can be applied. Since these roof tiles have very low surface roughness, only very small quantities of coloring agent needs to be applied.

FIG. 5 shows a perspective view of an underside 67 of the lower region 59 of the profiled profiling unit 26. On this underside 67 of the profiling unit 26 is provided a comb-like profile 40. This profile 40 is comprised of several webs 41 to 45 disposed next to one another, which are each spaced apart from one another by an interval distance b. The underside 67 of the profiling unit 26 has substantially the shape of a concrete body. Sections 68 to 71 of profile 40 are herein evident. Section 68 serves to provide a cover fold of a concrete body with a groove profile. Sections 69 to 71 serve to provide the two water courses of a concrete body with a groove profile. With section 70 a groove profile is applied onto a center brim. A section with which a water fold of a concrete body can also be provided with a groove profile is not provided in the profiling unit 26 depicted in FIG. 5. With the profiling unit 26 a water fold of a concrete body is therewith not provided with a profile.

Although not depicted in FIG. 5, the levelling unit 28 has the same form as the profiling unit 26, wherein the underside of the levelling unit 28 is smooth, which means that on the underside of the levelling unit 28 no profile is provided. A section for levelling, that is for smoothing a water fold of a concrete body, is not provided in the levelling unit 28, especially since on the water fold no groove profile is being disposed with the profiling unit 26.

FIG. 6 shows a segment of the profiling unit 26 depicted in FIG. 5, which has the comb-like profile 40 on its underside 67. This profile 40 comprises several webs 41 to 45 with rectangular structure. The webs 41 to 45 have herein a width a as well as a length c. The individual webs 41 to 45 are furthermore spaced apart from one another by the interval distance b. With respect to the dimensions a, b and c, the profile 40 can assume the following values: 0.5<a<3 mm, 0.5<b<3 mm and 1<c<4 mm. Especially preferred are herein ranges from 0.5<a<2 mm, 0.5<b<2 mm and 1<c<4 mm, in particular a=1 mm, b=1 mm and c=2 mm.

To shape the comb-like profile 40 such that it is dimensionally stable, the width a and the length c of the webs must have a balanced ratio with respect to each other. The ratio c/a is preferably in the range of 1.5 to 2, which means 1.5≦c/a≦2.

In contrast, via the distance b a limit value for the size-dependent separation of the sand particles is predetermined. If as the dimension b, for example, 1 mm is specified, coarse sand particles with a grain size >1 mm are displaced from the surface region of the concrete body 2, while the fine sand particles with a grain size <1 mm remain in the surface region and thus collect in the elevations (see FIG. 8, reference numbers 61 to 65) of the groove profile such that a surface layer can be formed of the fine concrete.

The choice of sand utilized for the production of the green concrete depends on the distance b, for the grading curve must be selected such that more than 60% of the sand particles have a grain size that is less than b. Only if this is ensured is the profile 40 adequately filled with fine sand particles and an adequate material flow through the profile 40 is ensured.

In FIG. 7 is depicted a variant of a profiled levelling unit 46 with a profile 47. This profile 47 is also structured in the shape of a comb, wherein profile 47 has webs 48 to 52 developed minimally conically. Due to these conically developed webs 48 to 52 the risk of the profile 47 to become clogged with concrete is lower.

It is understood that diversely profiled levelling units can also be selected provided that with them the separation of the sand particles according to their grain size is possible.

FIG. 8 shows the production of a groove profile on the upper side 1 of the concrete body 2 by means of the profiling unit 26. In FIG. 8 only a segment of the concrete body 2 as well as of the profiling unit 26 is shown. Visible is also the concrete layer 17 with sand particles of various sizes. By moving the concrete body 2 underneath and past the profiling unit 26, the upper side 1 is worked. Due to the defined distance b of webs 41 to 45 with respect to one another, only sand particles with a very specific diameter are moved through the comb-like profile 40. Sand particles with a diameter greater than b, are not conducted through the profile 40. Thereby in the intermediate spaces of the profiling unit 26 only sand particles accumulate whose grain size is less than b. In FIG. 8 are also visible several elevations 61 to 65 which are arranged in the intermediate spaces of the comb-like profile 40. In the elevations 61 to 65 are, consequently, only on average smaller sand particles than in the subjacent regions of layer 17.

FIG. 9 shows the levelling by means of the levelling unit 28 of the groove profile applied on the upper side 1 of the concrete body 2. In contrast to the profiling unit 26, this levelling unit 28 does not have a profile on its underside 60. With this levelling unit 28 the elevations 61 to 65 can be levelled, whereby the elevations 61 to 65 on the upper side 1 of the concrete body 2 can be pushed downwardly. Consequently, squashing of the elevations 61 to 65 takes place through the levelling unit 28. The upper side 1 of the concrete body 2 is smoothed through this levelling, whereby the upper region 19 is formed which is disposed above the region 18 and forms the surface layer. In region 19 only the smaller sand particles and in region 18 the smaller as well as also the larger sand particles are arranged. Through the smoothing, that is through the levelling of the groove profile, the larger sand particles are moved out of region 19 into region 18 such that in region 18 now only sand particles are arranged whose mean grain size is greatest. Through the smoothing not only the elevations 61 to 65 are obliterated but simultaneously it is also prevented that air collects in region 19. It is therefore also feasible to utilize very fine sand in the concrete mixture of the concrete body 2 since, through the profiling and the subsequent smoothing of the upper side 1 of the concrete body 2, air inclusions in the concrete are excluded.

If the profile of the profiling unit 26 has, for example, the dimensions a=1 mm, b=1 mm and c=2 mm, a sand with the grading curve listed in the following Table can be utilized.

| Grain Size Range [mm] | Percentage by Weight [%] |
|---|---|
| 0.00-0.19 | 9.8 |
| 0.20-0.39 | 37.4 |
| 0.40-0.59 | 27.3 |
| 0.60-0.99 | 12.3 |
| 1.00-1.29 | 3.7 |
| 1.30-1.59 | 2.7 |
| 1.60-1.99 | 2.5 |
| 2.00-3.19 | 3.3 |
| 3.20-4.00 | 1.0 |

As the Table shows, only 13.2% of the sand particles have a diameter of more than 1 mm. 86.8% of the sand particles have a diameter less than b, e.g. the diameter is less than 1 mm. Sand particles with a grain size greater than 1 mm are displaced into region 18 through the profiling unit 26, such that region 19 is free of sand particles having a grain size greater than 1 mm. In region 18 therewith more sand particles having a grain size greater than 1 mm are arranged than in region 27.

The thickness D of region 19 depends on the geometry of the profiling unit 26. The following relation applies herein:

D=(c*b)/(a+b)

Of advantage in levelling the previously applied groove profile is that a grain size distribution is obtained in which the larger sand particles are not arranged on the upper side of the concrete body and that here only sand particles with a smaller diameter are arranged. The concrete body hereby obtains not only a very smooth surface but the levelling of the elevations also contributes to the pores on the surface being smaller than in conventional concrete bodies, that is in concrete bodies in which no smoothing of a previously applied groove profile takes place. The concrete bodies produced in this manner have therefore improved surface quality.

FIG. 10 shows the concrete body 2 according to FIG. 2 after a groove profile 66 has been applied on its upper side 1 by means of the profiling unit 26 according to FIG. 5. Through the specific form of the profiling unit 26 the groove profile 66 is only disposed on the cover fold 6, the center brim 7 as well as on the two water courses 9 and 10. The water course 8, in contrast, does not have a groove profile. Since the water course 8 is overlapped by a cover fold of a further concrete body, improvement of the surface quality of the water fold 8, specifically with respect to appearance, is not of significance.

Formulated generally, the invention consequently relates to a method for the production of a concrete body 2 extruded from green concrete 33, characterized by the following sequential steps:
the concrete body 2 is moved to a profiling unit 26 which on its underside has at least partially a profile 40, 47, the profile 40, 47 being structured such that with the profile 40, 47 sand particles in the concrete body 2 can be separated according to their particle size;
by means of the profile 40, 47 of the profiling unit 26 on the upper side 1 of the concrete body 2 a groove profile 66 is applied, wherein in the groove profile 66 sand particles with a mean particle size are arranged whose mean particle size is less than the mean particle size of the green concrete 33;
the concrete body 2 with the groove profile 66 is moved to a levelling unit 28, with the levelling unit 28 having an underside developed such that with the underside of the levelling unit 28 the groove profile 66 of the concrete body 2 is levelled, whereby on the upper side 1 a surface layer 19 and a subjacent region 18 is formed, wherein in the surface layer 19 only those sand particles are arranged which before the levelling were arranged in the groove profile 66.

The invention further relates to a plant for the production of a concrete body 2 with a flat upper side 1, comprising a working station 29 with an extrusion arrangement 30 for extruding a concrete body 2 of green concrete 33 as well as a profiling unit 26, 46 downstream from the extrusion arrangement 30, characterized in that
the profiling unit 26, 46 on its underside is provided with a profile 40, 47 structured such that with the profile 40, 47 a groove profile 66 can be applied on the upper side 1 of the concrete body 2, wherein in the groove profile 66 sand particles with a mean particle size are arranged whose mean particle size is less than the mean particle size of the green concrete 33;
a levelling unit 28 downstream from the profiling unit 26, 46 is provided which has an underside 60 for levelling the groove profile 66, wherein the underside of the levelling unit 28 is developed such that after the levelling of the groove profile 66 the upper side 1 of the concrete body 2 has an upper region 19 as well as a subjacently disposed region 18, wherein the upper region 19 forms a surface layer, and the surface layer includes only the sand particles of the elevations of the groove profile 66.

Although the embodiment examples of the invention have been described above in detail, the invention is not limited to these embodiment examples. A person of skill in the art understands that the invention comprises diverse variants with which the same result is obtained as with the embodiment examples described here. It is therefore obvious for the person of skill in the art that with the embodiment examples described here the protective scope of the claims is not restricted and that there are further variants, modifications and alternatives which fall within the protective scope of the claims.

### REFERENCE NUMBERS

1 Upper side

2 Concrete body

3 Head-end section

4 Central section

5 Foot-end section

6 Cover fold

7 Center brim

8 Water fold

9 Water course

10 Water course

11 Underside

12 Cover fold rib

13 Cover fold rib

14 Water fold rib

15 Water fold rib

16 Water fold rib

17 Layer

18 Region

19 Region

20 Plant

21 Belt conveyor

22 Transport direction

23 Lower molds

24 Spiked shaft

25 Roller

26 Profiling unit

27 Region

28 Levelling unit

29 Working station

30 Extrusion arrangement

31 Surface working unit

32 Material box

33 Green concrete

34 Cutting station

35 Cutting tool

36 Double arrow

37 Double arrow

40 Profile

41 Web

42 Web

43 Web

44 Web

45 Web

46 Profiling unit

47 Profile

48 Web

49 Web

50 Web

51 Web

52 Web

59 Lower region

60 Underside

61 Elevation

62 Elevation

63 Elevation

64 Elevation

65 Elevation

66 Groove profile

67 Underside

68 Section

69 Section

70 Section

71 Section

1. Method for the production of a concrete body with a flat upper side, wherein from green concrete a concrete body is extruded which on its upper side is provided by a profiling unit having a comb-like profile with a groove profile, characterized in
that by means of the profiling unit and as a function of its comb-like profile a separation of the sand particles according to their particle size takes place,
that large sand particles are displaced inwardly from the surface region of the concrete body,
that fine sand particles pass the profile whereby elevations of the groove profile are formed which are comprised of fine-grained concrete, and
that the upper side of the concrete body is smoothed by means of a levelling unit, wherein the fine-grained concrete of the groove profile is distributed to form a surface layer.

2. Method as in claim 1, characterized in that the elevations of the groove profile are formed by webs, disposed parallel to one another, of the profile of the profiling unit, which are spaced apart at an interval distance b.

3. Method as in claim 2, characterized in that the green concrete includes sand particles, wherein at least 60% of the sand particles are smaller than the interval distance b of the webs with respect to one another of profile.

4. Method as in claim 1, characterized in that the concrete body is cut in a cutting station to form a roof tile.

5. Plant for the production of a concrete body with a flat upper side, comprising a working station with an extrusion arrangement for the extrusion of a concrete body from green concrete and a profiling unit downstream in the extrusion direction for generating a groove profile on the upper side of the concrete body, wherein the profiling unit includes a comb-like profile with webs extending in the extrusion direction and oriented parallel to one another, characterized in
that via an interval distance b of the webs with respect to one another a limit value for a size-dependent separation of the sand particles is predetermined and
that a levelling unit for levelling the profiled upper side of the concrete body is provided.

6. Plant for the production of a concrete body with a flat upper side as in claim 5, characterized in that for the application of the green concrete lower molds are provided which are conducted by a belt conveyor as a continuous strand to the extrusion arrangement.

7. Plant for the production of a concrete body with a flat upper side as in claim 5, characterized in that the profiling unit and the levelling unit form a surface working unit, wherein the profiling unit is disposed ahead of the levelling unit in the direction of movement.

8. Plant for the production of a concrete body with a flat upper side as in claim 5, characterized in that the profiling unit and the levelling unit have substantially the form of the concrete body.

9. Plant for the production of a concrete body with a flat upper side as in claim 5, characterized in that the plant includes a cutting station which cuts the concrete body into roof tiles.

10. Plant for the production of a concrete body with a flat upper side as in claim 5, characterized in that the webs of profile of the profiling unit have a length c and a width a, wherein the ratio c/a is in the range of 1.5 to 2.

11. Plant for the production of a concrete body with a flat upper side as in claim 10, characterized in that the profile has a geometry with the dimensions 0.5<a<3 mm, 0.5<b<3 mm and 1<c<4 mm.

12. Plant for the production of a concrete body with a flat upper side as in claim 5, characterized in that the distance b is selected such that more than 60% of the sand particles of the sand of the green concrete can be arranged between the webs.

13. Plant for the production of a concrete body with a flat upper side as in claim 11, characterized in that the profile has a geometry with the dimensions a=1 mm, b=1 mm and c=2 mm.
